(19) United States
(12) Patent Application Publication
(10) Pub. No.: US 2025/0060765 A1
(43) Pub. Date: Feb. 20, 2025

(54) A PRESSURE-INDEPENDENT CONTROL VALVE WITH A FLUID PRESSURE DISTRIBUTING SLEEVE, AND METHOD OF DISTRIBUTING FLUID PRESSURE

(71) Applicant: PITTWAY SARL, Rolle (CH)

(72) Inventors: Petr Svejnoha, Rolle (CH); Petr Fadrny, Rolle (CH)

(73) Assignee: PITTWAY SARL, Rolle (CH)

(21) Appl. No.: 18/720,282

(22) PCT Filed: Dec. 31, 2021
(86) PCT No.: PCT/EP2021/087906

§ 371 Date: Jun. 14, 2024

(51) Int. Cl. G05D 7/01

(52) U.S. Cl. CPC G05D 7/0113

(57) ABSTRACT

The invention relates to a pressure independent control valve comprising: a valve body comprising a fluid inlet and a fluid outlet, a fluid path between the fluid inlet and the fluid outlet; a pressure differential control; and a sleeve inserted within the valve body; whereby the pressure differential control comprises a chamber in fluid communication with the fluid inlet or the fluid outlet. When the chamber is in fluid communication with the fluid outlet, the sleeve comprises a first fluid channel extending between the fluid outlet and the chamber to provide the fluid communication between the fluid outlet and the second chamber. Alternatively, when the chamber is in fluid communication with the fluid inlet, the sleeve comprising a second fluid channel extending between the fluid inlet and the chamber to provide the fluid communication between the fluid inlet and the chamber. The invention also relates to a fluid system comprising the pressure-independent control valve comprising the sleeve and to a method of distributing fluid pressure using the pressure-independent control valve with the sleeve.

### FIELD OF INVENTION

The invention relates to pressure-independent control valves having a fluid pressure distributing sleeve, and to distributing fluid pressure in said valves.

### BACKGROUND

Pressure-independent control valves (PICV) can regulate a flow of fluid, and keep it constant, even during variable pressure conditions. PICVs are commonly used in fluid systems such as, for example, in heating, ventilation and air conditioning (HVAC) systems for controlling the flow of fluid through the conduits of the system. For example, a PICV may be used in a HVAC fluid system to control the flow of water through a conduit in order to provide heating or cooling.

Pressure-independent control valves (PICV) typically comprise a fluid inlet where the fluid has pressure P1, a fluid outlet where the fluid has pressure P3, and a fluid path extending between the fluid inlet and the fluid outlet where the fluid has a pressure P2. The pressure differs through the valve whereby P1>P2>P3.

Pressure-independent control valves (PICV) comprise a pressure differential control to maintain a constant pressure difference, and thereby maintain a constant flow rate of fluid regardless of any changes in pressure.

To provide the constant pressure difference, fluid at the fluid inlet and/or the fluid outlet has to be communicated to the pressure differential control. Conventionally, this is achieved by using a fluid channel that extends within the valve body. Providing the fluid channel within the valve body requires high precision machining. The machining process is complex and expensive, and there is risk of damaging the fluid channel and/or other components of the valve during machining.

### SUMMARY

The invention seeks to address and/or ameliorate the problems of pressure independent control valves described above.

A first aspect of the invention relates to a pressure independent control valve comprising:
a valve body comprising a fluid inlet and a fluid outlet,
a fluid path between the fluid inlet and the fluid outlet;
a pressure differential control; and
sleeve inserted within the valve body;
whereby the pressure differential control comprises a chamber in fluid communication with the fluid inlet or the fluid outlet;
   whereby when the chamber is in fluid communication with the fluid outlet, the sleeve comprises a first fluid channel extending between the fluid outlet and the chamber to provide the fluid communication between the fluid outlet and the chamber,
   or
   whereby when the chamber is in fluid communication with the fluid inlet, the sleeve comprises a second fluid channel extending between the fluid inlet and the chamber to provide the fluid communication between the fluid inlet and the chamber.

When the chamber is in fluid communication with the fluid outlet, the first fluid channel is configured to guide fluid to flow from the fluid outlet into the chamber. As such, the chamber has the same fluid pressure as the fluid outlet.

Alternatively, when the chamber is in fluid communication with the fluid inlet, the second fluid channel is configured to guide fluid to flow from the fluid inlet into the chamber. As such, the chamber has the same fluid pressure as the fluid inlet.

The valve may comprise a fluid path pressure sensor and the sleeve may further comprise a third fluid channel extending between the fluid path and the fluid path pressure sensor.

Hence, the third fluid channel is configured to guide fluid to flow from the fluid path to the fluid path pressure sensor to allow for the fluid pressure in the fluid path to be monitored by the fluid path pressure sensor.

When the chamber is in fluid communication with the fluid outlet, the valve may comprise a fluid outlet pressure sensor and the sleeve may comprise a fourth fluid channel extending between the fluid outlet and a fluid outlet pressure sensor. The fourth fluid channel is configured to guide fluid to flow from the fluid outlet to the fluid outlet pressure sensor to allow for the fluid pressure in the fluid outlet to be monitored by the fluid outlet pressure sensor.

Or alternatively, when the chamber is in fluid communication with the fluid inlet, the valve may comprise a fluid inlet pressure sensor and the sleeve may comprise a fifth fluid channel extending between the fluid inlet and a fluid inlet pressure sensor. The fifth fluid channel is configured to guide fluid to flow from the fluid inlet to the fluid inlet pressure sensor to allow for the fluid pressure in the fluid inlet to be monitored by the fluid inlet pressure sensor.

Advantageously, the one or more fluid channels of the sleeve distribute fluid to different regions of the valve. As such, the sleeve is able to distribute fluid pressure within the valve.

Advantageously, by using the sleeve with one or more fluid channels, no fluid channel need extend within the valve body of the valve.

Advantageously, the sleeve is a separate component to the valve body, being separately formed from the valve body. The one or more fluid channel may be formed within the sleeve or defined by the sleeve when inserted in the valve body. The one or more fluid channels may formed simply and quickly within the sleeve or defined by the sleeve, and without machining the valve body.

The sleeve may be configured to house the fluid path and/or the pressure differential control.

The valve may further comprise a fluid flow control to control the flow of fluid. The sleeve may be configured to house the fluid flow control.

When the chamber of the pressure differential control is in fluid communication with the fluid outlet, the pressure differential control may be configured to control a pressure differential between the fluid path and the fluid outlet.

When the chamber of the pressure differential control is in fluid communication with the fluid inlet, the pressure differential control may be configured to control a pressure differential between the fluid path and the fluid inlet.

The sleeve may comprise a plastic material. The sleeve may be manufactured by an injection moulding technique.

A second aspect of the invention relates to a fluid system comprising:
a pressure-independent control valve according to the first aspect of the invention:
a first fluid pipe coupled to the fluid inlet of the valve;
a second fluid pipe coupled to the fluid outlet of the valve.

A third aspect of the invention relates to a method of distributing fluid pressure in a pressure-independent control valve according to the first aspect of the invention comprising:
when the chamber is in fluid communication with the fluid outlet and the first fluid channel of the inserted sleeve extends between the chamber and the fluid outlet, guiding fluid to flow from the fluid outlet to the chamber via the first fluid channel of the inserted sleeve;
or
when the chamber is in fluid communication with the fluid inlet and the second fluid channel of the inserted sleeve extends between the chamber and the fluid inlet, guiding fluid to flow from the fluid inlet to the chamber via the second fluid channel of the inserted sleeve.

The method may comprise:
guiding fluid to flow from the fluid path to the fluid path pressure sensor via the third fluid channel formed in the inserted sleeve;
monitoring the fluid pressure of the fluid path using the fluid path pressure sensor.

The method may comprise:
when the chamber is in fluid communication with the fluid outlet and the fourth channel of the inserted sleeve extends between the fluid outlet and the fluid outlet pressure sensor:
   guiding fluid to flow from the fluid outlet to the fluid outlet pressure sensor via the fourth channel of the inserted sleeve; and
   monitoring the fluid pressure of the fluid outlet using the fluid outlet pressure sensor;
   or
when the chamber is in fluid communication with the fluid inlet outlet and the fifth channel of the inserted sleeve extends between the fluid inlet and the fluid inlet pressure sensor:
   guiding fluid to flow from the fluid inlet to the fluid inlet pressure sensor via the fifth channel of the inserted sleeve;
   monitoring the fluid pressure of the fluid inlet using the fluid inlet pressure sensor.

### BRIEF DESCRIPTION OF THE DRAWINGS

For a better understanding and to show how it may be carried into effect, reference will now be made, by way of example only, to the accompanying drawings, in which:

FIG. 1 is an external view of an embodiment of a pressure independent controlled valve according to the present invention;

FIG. 2 is a cross-sectional view of the embodiment of the valve according to the present invention;

FIGS. 3a and 3b are cross-sectional views of the embodiment of the valve according to the present invention where the fluid flow control is arranged in different positions;

FIG. 4 is a side view of the sleeve of the valve according to the present invention, where the sleeve is housing a pressure differential control and a fluid flow control;

FIG. 5a is a side view of the flow fluid control of the valve according to the present invention;

FIG. 5b is a cross-sectional view of the flow fluid control of the valve according to the present invention.

### DETAILED DESCRIPTION

Features described in the following detailed description can be combined to arrive at specific embodiments not explicitly described herein.

The same reference numbers in the drawings designate the same or corresponding elements.

Throughout the detailed description, the terms “valve” and “pressure-independent control valve”, and the abbreviation “PICV” are used interchangeably.

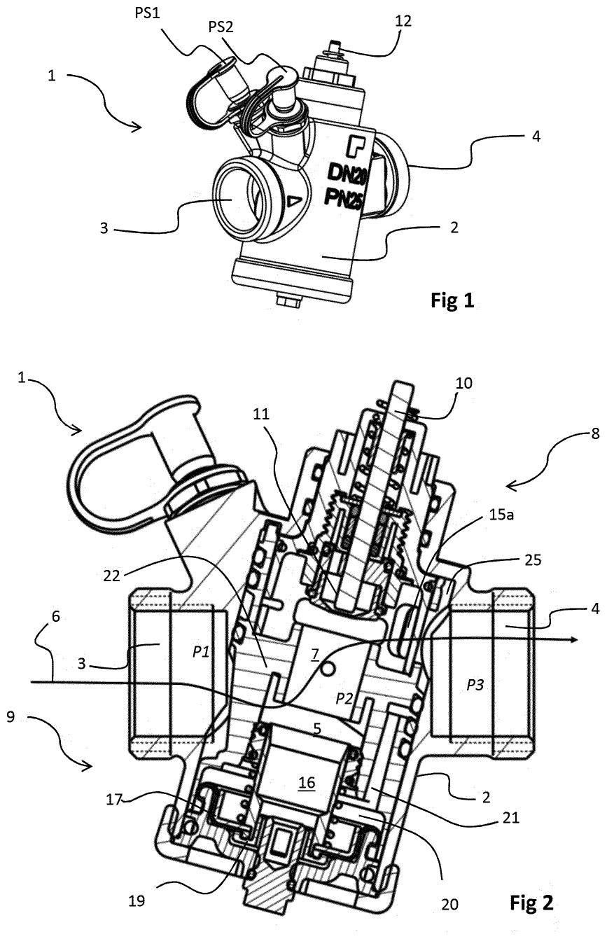

An embodiment of a pressure-independent control valve with a sleeve is shown in FIGS. 1 to 5b. This embodiment of the invention is not intended to be limiting.

As shown in the Figures, the valve 1 according to the invention comprises a valve body 2. The valve body 2 may have a generally tubular shape, or any suitable shape. The valve body 2 comprises a fluid inlet 3 and a fluid outlet 4. A fluid path 5 extends through the valve body 2, between the fluid inlet 2 and fluid outlet 4. In the embodiment shown in the Figures, the fluid inlet 3 and fluid outlet 4 are arranged on opposing sides of the valve body 2 and are co-axial.

The valve 1 is arrangeable in a fluid system to control the flow of fluid. The fluid system may be an HVAC fluid system. The fluid inlet 3 and fluid outlet 4 may be coupled to fluid pipes of the fluid system.

When the valve 1 is operating in fluid control mode, fluid enters the valve 1 via the fluid inlet 3, flows along the fluid path 5 and exits the valve via the fluid outlet 4. Arrow 6 of FIG. 2 depicts the general directional flow of fluid through the valve 1 when operating in fluid control mode.

In the embodiment shown in the Figures, the fluid path 5 comprises an upstream fluid path region 5a and a downstream fluid path region 5b. The upstream fluid path region 5a and downstream fluid path region 5b are in fluid communication via an adjustment orifice 7 that is arranged within the fluid path. The upstream fluid path 5a is in fluid communication with the fluid inlet 3. The downstream fluid path 5b is in fluid communication with the fluid outlet 4. Fluid within the fluid inlet 3 has a first pressure P1, fluid within the fluid path 5 has a pressure P2 and fluid within the fluid outlet 4 has a third pressure P3. The pressure decreases through the valve whereby P1>P2>P3.

The valve 1 of the present invention comprises a fluid flow control 8 for controlling the volume of fluid through the valve. In the embodiment shown in the Figures, the fluid flow control 8 is arranged in the downstream flow path region 5b and is configured to control the volume of fluid through the adjustment orifice 7.

The valve 1 of the present invention comprises a pressure differential control 9 for controlling the pressure difference of the fluid to maintain a constant pressure different across the valve, and thereby maintain a constant flow rate of fluid regardless of any operating changes (variations) in pressure. The pressure differential control may be configured to control the pressure difference between fluid pressure P1 within the fluid inlet 3 and the fluid pressure P2 within the fluid path 5. Alternatively, the pressure differential control may be configured to control the pressure difference between the fluid pressure P2 in the fluid path 5 and the fluid pressure P3 within the fluid outlet 4. In the embodiment shown in the Figures, the pressure differential control 9 is arranged in the upstream fluid path region 5a and is configured to control the pressure difference between the fluid pressure P2 within the fluid path 5 and the fluid pressure P3 within the fluid outlet 4.

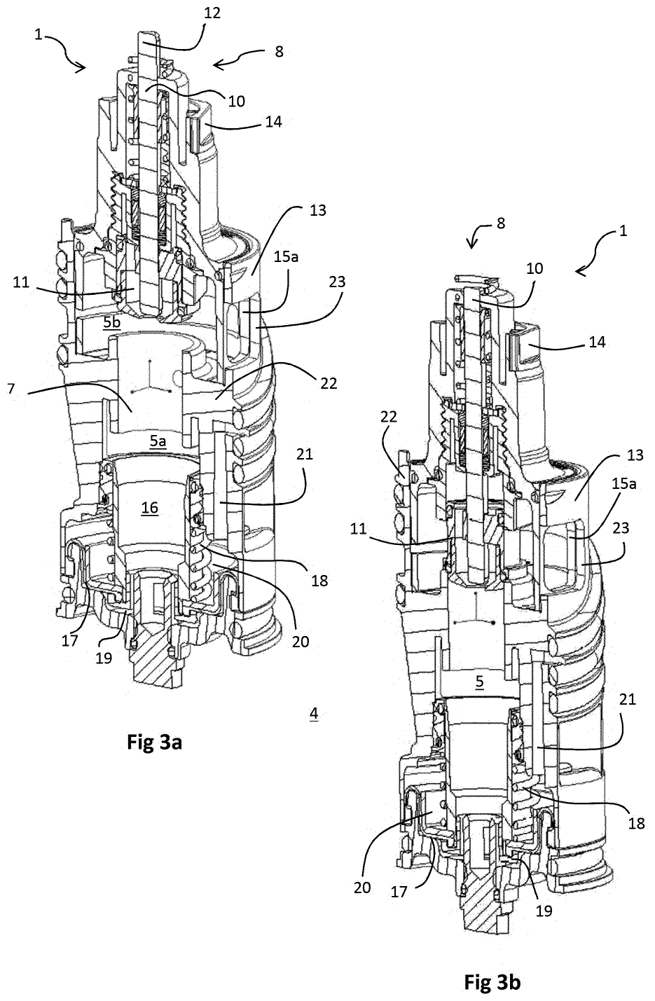

In the embodiment shown in the Figures, the fluid flow control 8 may comprise a pin 10, a cone 11 coupled to the distal end of the pin, and an pin actuator 12 coupled to a proximal end of the pin. The pin 10 is linearly movable under the actuation of the pin actuator 12, and the linear motion of the pin 10 linearly moves the cone 11 in a direction towards or away from the adjustment orifice 7. The movement of the cone 11 relative to the adjustment orifice 7 controls the volume flow rate of fluid through the adjustment orifice 7. As the cone 11 moves towards the adjustment orifice 7, the volume of fluid through the adjustment orifice 7 decreases. As the cone 11 moves away from the adjustment orifice 7 the volume of fluid through the adjustment orifice 7 increases. The cone 11 is movable under the actuation of the pin actuator 12 between an open position and a closed position relative to the adjustment orifice 7, and any position therebetween. When the cone 11 is in the open position, the adjustment orifice 7 is fully open and the volume flow rate through the adjustment orifice 7 is a maximum volume flow rate (see FIG. 3a). To prohibit the flow of fluid through the valve, the cone may be moved to engage and close the adjustment orifice 7 (see FIG. 3b). The pin actuator 12 may be rotated, pressed or otherwise actuated to move the pin 10 and thereby regulate the volume flow rate of fluid through the valve 1 as desired.

Alternatively or additionally, and as shown in the Figures, the fluid flow control 8 may comprise a shutter 13 and a shutter actuator 14 coupled to the shutter 13. The shutter 13 is arranged adjacent the fluid outlet 4. The shutter 13 is movable under the actuation of the shutter actuator 14 between an open and a closed position relative to the fluid outlet 4, and any position therebetween. When the shutter 13 is in the open position, the fluid outlet 4 is open. When the shutter 13 is in the closed position, the fluid outlet 4 is closed. The shutter comprises a first window 15a defining a first volume flow rate and a wall (not shown). When the shutter is in the open position, the first window is at least substantially aligned with the fluid outlet 4, to allow fluid to flow through the fluid outlet 4 with a first volume flow rate. When the shutter is in the closed position, the wall is at least substantially aligned with the fluid outlet 4, so as to seal and prohibit the flow of fluid through the fluid outlet 4. The shutter may be arranged in a partially open position, whereby the first window is partially aligned with the fluid outlet 4. As such, fluid may flow through the fluid outlet at a reduced volume flow rate, less than the defined first volume flow rate. The shutter may comprise multiple windows defining different volume flow rates. For example, as shown, in the Figures, the shutter 13 may further comprise a second window 15b defining a second volume flow rate, and a third window 15c defining a third volume flow rate. The shutter actuator 14 may operate separately or in conjunction with the pin actuator 12. The shutter 13 may be actuated sequentially and/or simultaneously to the cone 11. The shutter actuator 14 may be rotated, pressed or otherwise actuated to move the shutter 13, and thereby regulate the volume flow rate of fluid through the valve 1 as desired.

In the embodiment shown in the Figures, where the pressure differential control 9 is configured to the control the pressure differential between the fluid path 5 and the fluid outlet 4, the pressure differential control may comprise a piston 16, a diaphragm 17 (or other suitable flexible membrane) connected to the piston, and a spring 18 (or other suitable elastic member) acting on the upperside of the diaphragm 17. The piston 16 is linearly movable under the actuation of the diaphragm 17 in a direction towards or away from the adjustment orifice 7. The diaphragm 17 extends between a first chamber 19 and a second chamber 20, whereby the first chamber 19 is arranged below the diaphragm 17 and the second chamber 20 is arranged above the diaphragm 17. The first chamber 19 is in fluid communication with the fluid path 5 and so comprises fluid from the fluid path having a pressure P2. In the embodiment shown in the Figures, the piston 16 is hollow and defines a fluid channel between the fluid path 5 and the first chamber 19. As such, the first chamber 19 is in fluid communication with the fluid path 5 via the piston 16. The second chamber 20 is in fluid communication with the fluid outlet 4 and so comprises fluid from the fluid outlet 4 having a pressure P3. In the embodiments shown in the Figures, the valve 1 further comprises a first fluid channel 21 extending between the second chamber 20 and the fluid outlet 4. As such, the second chamber 20 is in fluid communication with the fluid outlet 4 via the fluid channel 21.

In operation, during fluid control mode, the underside of the diaphragm 17 is subject to a force exerted by the fluid at pressure 2 in the first chamber 19. The upperside of the diaphragm is subject to a force exerted by the fluid at pressure P3 in the second chamber 20 and the force exerted by the spring 18. The equilibrium of the forces acting on the diaphragm 17 determines the position of the diaphragm 17, and thereby the position of the piston 16 relative to the adjustment orifice 7. The position of the diaphragm 17, and thereby the position of the piston 16 relative to the adjustment orifice 7, adjusts automatically to any variations in fluid pressure P1 and/or P3 so as to maintain a constant pressure differential between P2 and P3.

The skilled person will understand the alternative arrangement of the pressure differential control when configured to control the pressure differential between the fluid path 5 and the fluid inlet 3, where the first chamber 19 is in fluid communication with the fluid inlet 3 and the second chamber is in communication with the fluid path 5. A second fluid channel will extend between the fluid inlet 3 and the first chamber 19 to provide the fluid communication.

In the present invention, the valve 1 further comprises a sleeve 22 inserted within valve body 2. The sleeve 22 is a separate component to the valve body 2. The sleeve 22 preferably conforms to the inner profile of the valve body 2 and forms a close fit. As such, the sleeve 22 acts as a liner within the valve body 2. The sleeve 22 may have a tubular shape, or any other suitable shape.

In the invention, and in the embodiment shown in the Figures, the sleeve 22 may comprise a sleeve inlet aperture (not shown) aligned with the fluid inlet 3, and a sleeve outlet aperture 23 aligned with the fluid outlet 4. The sleeve 22 may house the fluid path 5 extending between the fluid inlet 3 and fluid outlet 4. As such, the sleeve 22 may house the adjustment orifice 7 arranged in the fluid path 5.

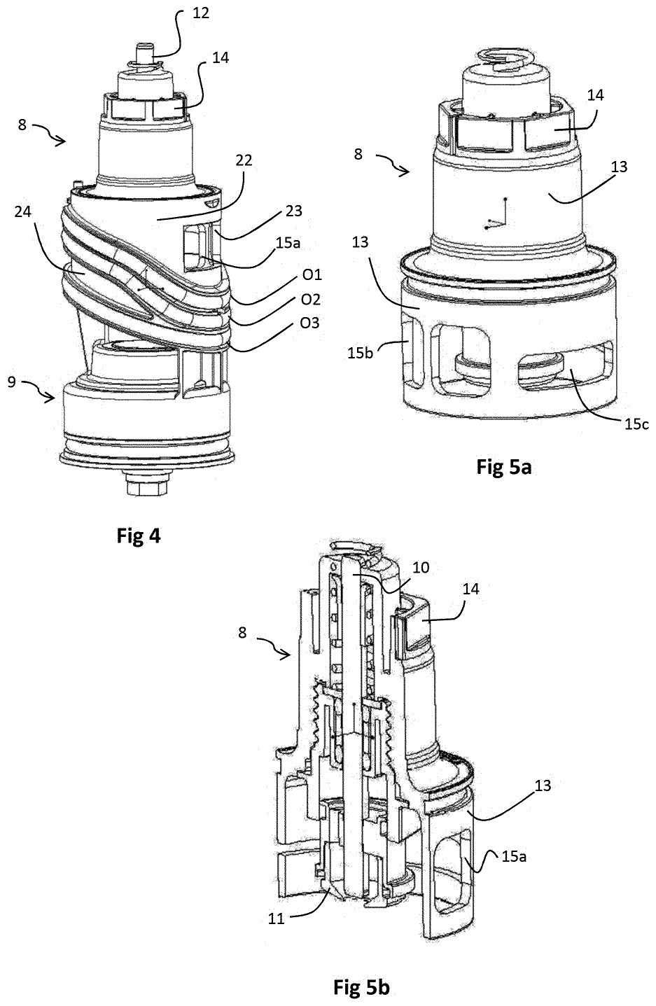

In the invention, and in the embodiment shown in the Figures, the sleeve 22 may house the fluid flow control 8, whereby at least a portion of the fluid flow control 8 is arranged within the sleeve 22. As shown in the Figures, the sleeve 22 may house the shutter 13, whereby the sleeve is configured between the shutter 13 and the valve body 2. As such, when the shutter is arranged in the open position, the first window 15a, sleeve outlet aperture 23 and fluid outlet 4 are substantially aligned-see FIG. 4.

In the invention, and in the embodiment shown in the Figures, the sleeve 22 may also house the pressure differential control 9, whereby at least a portion of the differential control 9 is arranged within the sleeve 22.

In the invention, the sleeve 22 may comprise one or more fluid channels to transfer fluid, and thereby fluid pressure between one or more region of the valve 1 to another. For example, in the embodiment shown in the Figures where the second chamber 20 of the pressure differential control 9 is in fluid communication with the fluid outlet 4 (where the pressure differential control 9 is configured to control a pressure differential between the fluid path 5 and the fluid outlet 4) the sleeve 22 may comprise the first fluid channel 21 extending between the fluid outlet 4 and the second chamber 20 to transfer fluid having the third pressure P3 from the fluid outlet 4 to the second chamber 20. In the embodiment as shown in the Figures, the fluid channel 21 may be formed internally within the sleeve 22.

In an alternative embodiment where the first chamber 19 of the pressure differential control 9 is in fluid communication with the fluid inlet 3 (where the pressure differential control 9 is configured to control a pressure differential between the fluid path 5 and the fluid inlet 3), the sleeve 22 may comprise a second fluid channel (not shown) extending between the fluid inlet 3 and the first chamber 19 to transfer fluid having the first pressure P1 from the fluid inlet 3 to the first chamber 19. The second fluid channel extending between the fluid inlet 3 and the first chamber 19 may be formed internally within the sleeve 22.

In the invention, and in the embodiment of the valve shown in the Figures, the valve may comprise a fluid path pressure sensor PS1 to monitor the fluid pressure P2 in the fluid path. In the invention, and in embodiment of the valve shown in the Figures, the sleeve 22 may also comprise a third fluid channel 24 extending between the fluid path 5 and the fluid path pressure sensor PS1. The third fluid channel 24 transfers fluid from the fluid path 5, and therefore fluid pressure P2, to the fluid path pressure sensor PS1 so that the pressure P2 of the fluid path 5 can be monitored. The third fluid channel 24 may have any suitable configuration. At least a portion of the third fluid channel 24 may extend along the outer surface of the sleeve 22 between the fluid path 5 and the fluid path pressure sensor PS1. The third fluid channel 24 may comprise a recess (groove, indent) formed in the outer surface of the sleeve. The third fluid channel 24 may comprise a gap space defined between seals and/or the outer surface of the sleeve and the inner surface of the valve body. In the embodiment shown in the Figures, the third fluid channel 24 comprises a spiralling channel arranged on the outer surface of the sleeve 22. One end of the spiralling channel is arranged in fluid communication with the fluid path 5, whilst the other end of the second fluid channel is arranged in fluid communication with the fluid path pressure sensor PS1. The spiralling channel is defined by O-ring seals O2, O3 mounted on the outer surface of the sleeve.

In the invention, and in the embodiment shown in the Figures, if the pressure differential control is configured to control the pressure differential between the fluid path 5 and the fluid outlet 4 then the valve may comprise a fluid outlet sensor PS2 to monitor the fluid pressure P3 in the fluid outlet 4. In the invention, and in the embodiment shown in the Figures, the sleeve 22 may also comprise a fourth channel 25 extending between the fluid outlet 4 and the fluid outlet pressure sensor PS2. The fourth channel 25 transfers fluid from the fluid outlet 4, and therefore fluid pressure P3, to the fluid outlet pressure sensor PS2 so that the pressure P3 of the fluid outlet 4 can be monitored. The fourth fluid channel 25 may have any suitable configuration At least a portion of the fourth fluid channel 25 may extend along the outer surface of the sleeve 22 between the fluid outlet 4 and the fluid outlet pressure sensor PS2. The fourth fluid channel 25 may comprise a recess (groove, indent) formed in the outer surface of the sleeve. The fourth fluid channel 25 may comprise a gap space defined between seals and/or the outer surface of the sleeve and the inner surface of the valve body. In the embodiment shown in the Figures, the fourth fluid channel 25 comprises a gap space channel formed in a space between the outer surface of the sleeve 22 and the inner surface of the valve body 2. The gap space is further defined by O-ring O1 whereby the O-ring is positioned to arrange the gap space in a region of low turbulence. One end of the gap space channel is arranged in fluid communication with the fluid outlet 4, whilst the other end of the gap space channel is arranged in fluid communication with the fluid outlet pressure sensor PS2.

Together, the fluid path pressure sensor PS1 and the fluid outlet pressure sensor PS2 can monitor the pressure at the fluid path 5 and fluid outlet 4 to identify the pressure differential control is maintaining a constant pressure different between fluid pressures P2 and P3.

In an alternative embodiment, where the pressure differential control is configured to control the pressure differential between the fluid path 5 and the fluid inlet 3, then the valve may comprise a fluid inlet sensor (not shown) to monitor the fluid pressure P1 in the fluid inlet 3. The sleeve 22 may also comprise a fifth fluid channel (not shown) extending between the fluid inlet 3 and the fluid inlet pressure sensor. The fifth fluid channel transfers fluid from the fluid inlet 3, and therefore fluid pressure P1, to the fluid inlet pressure sensor so that the pressure P1 of the fluid inlet 3 can be monitored. The fifth fluid channel may have any suitable configuration. For example, at least a portion of the fifth fluid channel may extend along the outer surface of the sleeve 22 between the fluid outlet 4 and the fluid inlet pressure sensor. The fifth fluid channel may comprise a recess (groove, indent) formed in the outer surface of the sleeve. The fifth fluid channel may comprise a gap space defined between seals and/or the outer surface of the sleeve and the inner surface of the valve body.

Together, the fluid path pressure sensor PS1 and the fluid inlet pressure sensor can monitor the pressure at the fluid path 5 and the fluid inlet 3 to identify the pressure differential control is maintaining a constant pressure different between fluid pressures P1 and P2.

The sleeve may be formed from a plastic material. The sleeve may be manufactured using an injection moulding technique. Hence, the fluid channels may be moulded into the sleeve.

It will be appreciated by persons skilled in the art that the above embodiments have been described by way of example only and not in any limitative sense, and that various alterations and modifications are possible without departing from the scope of the invention as defined by the appended claims.

1. A pressure independent control valve comprising:
a valve body comprising a fluid inlet and a fluid outlet,
a fluid path between the fluid inlet and the fluid outlet;
a pressure differential control; and
a sleeve inserted within the valve body;
whereby the pressure differential control comprises a chamber in fluid communication with the fluid inlet or the fluid outlet;
whereby when the chamber is in fluid communication with the fluid outlet, the sleeve comprising a first fluid channel extending between the fluid outlet and the chamber to guide fluid to flow from the fluid outlet to the chamber, or
whereby when the chamber is in fluid communication with the fluid inlet, the sleeve comprising a second fluid channel extending between the fluid inlet and the chamber to guide fluid to flow from the fluid inlet to the chamber.

2. The pressure independent control valve according to claim 1, further comprising a fluid path pressure sensor; and
wherein the sleeve further comprising a third fluid channel extending between the fluid path and the fluid path pressure sensor to guide fluid from the fluid path to the fluid path pressure sensor.

3. The pressure independent control valve according to claim 1,
wherein when the chamber is in fluid communication with the fluid outlet:
the pressure independent control valve further comprising a fluid outlet pressure sensor; and
the sleeve comprising a fourth fluid channel extending between the fluid outlet and a fluid outlet pressure sensor to guide fluid from the fluid outlet to the fluid outlet pressure sensor; or
wherein when the chamber is in fluid communication with the fluid inlet:
the pressure independent control valve further comprising a fluid inlet pressure sensor, and
the sleeve further comprising a fifth fluid channel extending between the fluid inlet and a fluid inlet pressure sensor to guide fluid to flow from the fluid inlet to the fluid inlet pressure sensor.

4. The pressure independent control valve according to claim 1, wherein the sleeve comprises a plastic material.

5. The pressure independent control valve according to claim 1, wherein the sleeve is manufactured by an injection moulding technique.

6. A fluid system comprising:
the pressure-independent control valve according to claim 1;
a first fluid pipe coupled to the fluid inlet of the pressure independent control valve; and
a second fluid pipe coupled to the fluid outlet of the pressure independent control valve.

7. A method of distributing fluid pressure in a pressure-independent control valve, the method comprising:
when a chamber is in fluid communication with a fluid outlet and a first fluid channel of an inserted sleeve extends between the chamber and the fluid outlet,
guiding fluid to flow from the fluid outlet to the chamber via the first fluid channel of the inserted sleeve; or
when the chamber is in fluid communication with a fluid inlet and a second fluid channel of the inserted sleeve extends between the chamber and the fluid inlet,
guiding fluid to flow from the fluid inlet to the chamber via the second fluid channel of the inserted sleeve.

8. The method according to claim 7 comprising:
guiding fluid to flow from a fluid path to a fluid path pressure sensor via a third fluid channel formed in the inserted sleeve; and
monitoring the fluid pressure of the fluid path using the fluid path pressure sensor.

9. The method according to claim 7,
wherein when the chamber is in fluid communication with the fluid outlet and a fourth channel of the inserted sleeve extends between the fluid outlet and a fluid outlet pressure sensor, comprising:
guiding fluid to flow from the fluid outlet to the fluid outlet pressure sensor via the fourth channel of the inserted sleeve; and
monitoring the fluid pressure of the fluid outlet using the fluid outlet pressure sensor; or
wherein when the chamber is in fluid communication with the fluid inlet outlet and a fifth channel of the inserted sleeve extends between the fluid inlet and a fluid inlet pressure sensor, comprising:
guiding fluid to flow from the fluid inlet to the fluid inlet pressure sensor via the fifth channel of the inserted sleeve; and
monitoring the fluid pressure of the fluid inlet using the fluid inlet pressure sensor.

10. The pressure independent control valve according to claim 2,
wherein when the chamber is in fluid communication with the fluid outlet:
the pressure independent control valve further comprising a fluid outlet pressure sensor; and
the sleeve comprising a fourth fluid channel extending between the fluid outlet and a fluid outlet pressure sensor to guide fluid from the fluid outlet to the fluid outlet pressure sensor; or
wherein when the chamber is in fluid communication with the fluid inlet:
the pressure independent control valve further comprising a fluid inlet pressure sensor, and
the sleeve further comprising a fifth fluid channel extending between the fluid inlet and a fluid inlet pressure sensor to guide fluid to flow from the fluid inlet to the fluid inlet pressure sensor.

11. The pressure independent control valve according to claim 2, wherein the sleeve comprises a plastic material.

12. The pressure independent control valve according to claim 2, wherein the sleeve is manufactured by an injection moulding technique.

13. The method according to claim 8,
wherein when the chamber is in fluid communication with the fluid outlet and a fourth channel of the inserted sleeve extends between the fluid outlet and a fluid outlet pressure sensor, comprising:
guiding fluid to flow from the fluid outlet to the fluid outlet pressure sensor via the fourth channel of the inserted sleeve; and
monitoring the fluid pressure of the fluid outlet using the fluid outlet pressure sensor; or
wherein when the chamber is in fluid communication with the fluid inlet and a fifth channel of the inserted sleeve extends between the fluid inlet and a fluid inlet pressure sensor, comprising:
guiding fluid to flow from the fluid inlet to the fluid inlet pressure sensor via the fifth channel of the inserted sleeve; and
monitoring the fluid pressure of the fluid inlet using the fluid inlet pressure sensor.
